(19) United States
(12) Patent Application Publication
(10) Pub. No.: US 2012/0260862 A1
(43) Pub. Date: Oct. 18, 2012

(54) Vibration Reduction Pad

(76) Inventor: Paul H. Alexander, New Plymouth, ID (US)

(21) Appl. No.: 13/448,120

(22) Filed: Apr. 16, 2012

Related U.S. Application Data
(60) Provisional application No. 61/475,558, filed on Apr. 14, 2011.

(51) Int. Cl. B60P 3/04; A01K 29/00; F16F 7/00

(52) U.S. Cl. 119/403; 267/141

(57) ABSTRACT

A vibration reduction pad suitable for the floors of animal transport or containment systems uses a core of one or more laminations of material sealed with an outer layer of moisture-proof, puncture and abrasion resistant woven fabric. The outer layer protects the core against outside contaminates. Multiple vibration reduction pads can be fitted edge to edge and sealed or multiple cores can be sealed in one outer layer allowing for custom fits in a wide variety of flooring situations.

### CROSS REFERENCE TO RELATED APPLICATIONS

This application claims the benefit of the provisional application entitled “Vibration Reduction Pad” by Paul Alexander, Ser. No. 61/475558 filed on Apr. 14, 2011 and is hereby incorporated by reference in its entirety.

### FEDERALLY SPONSORED RESEARCH OR DEVELOPMENT

Not applicable.

### JOINT RESEARCH AGREEMENT

Not applicable

### SEQUENCE LISTING

Not applicable

### FIELD OF THE INVENTION

The present invention relates to the field of mats and pads used in flooring systems for animals and in particular for pads used in the flooring of transport systems for animals.

### BACKGROUND OF THE INVENTION

Many times animals must be transported in trailers, trucks, rail cars and similar types of transportation. Horses, cattle, sheep and other animals are frequently transported. With animals accustomed to long periods of standing, vibration transmitted through the floor of the transport can be problematic. Even without incidents of high stress due to impact, kicking or stamping of hooves, vibration can irritate or damage the bones and joints of animals. During transit, vibration stress to the bones and joints of horses in particular, causes them to rock back and forth onto their hind quarters in order to relieve stress to joints, causing exhaustive muscle fatigue over long periods of time. Show and riding horses are especially susceptible because they travel many hours between rodeos or other equestrian competitions.

### SUMMARY OF THE INVENTION

In one embodiment a vibration reduction pad adapted to the floors of animal transport and containment systems, has a core of one or more foam laminations. The foam laminations have a density ranging from 5 to 10 pounds per cubic foot, the core has a thickness ranging from 0.5 to 1.0 inches. An outer layer of moisture-proof, puncture and abrasion resistant woven fabric protects the core against outside contaminates. The fabric has a weight between 18 and 45 ounces per square yard. This outer layer further surrounds all sides and faces of the core, sealing the core layer against outside contaminates.

The core laminations typically consist of polyethylene, polyolefin, polyurethane and combinations thereof. Other embodiments use these materials in combination with other materials. In other embodiments the core laminations are further laminated together with adhesive.

The outer layer which surrounds all sides and faces of the core, can be sealed with adhesives in some embodiments while other embodiments employ heat sealing techniques where portions of the outer layer are fused together to seal out contaminates thus protecting the core .

Some applications use a multiple of vibration reduction pads sealed at their adjoining edges. Vibration reduction pads are placed edge to edge to cover a transport floor for example. Sealing tape holds the edges together while also sealing out contaminates.

Still other embodiments include a layer of silicone gel layer having a thickness ranging from 0.25 to 0.5 inches, interposed between two laminations. This embodiment offers vibration reduction and cushioning.

In yet other embodiments an animal containment unit has a floor with one of the vibration reduction pads described earlier, placed on top. A rubber mat is then placed on top of the vibration reduction pad.

Uses include animal containment systems such as stalls, pens and barns as well as animal transportation such as horse trailers, cattle trucks and rail cars.

### BRIEF DESCRIPTION OF THE DRAWINGS

The summary above, and the following detailed description will be better understood in view of the enclosed figures which depict details of various embodiments. Like reference numbers designate like elements. It should however be noted that the invention is not limited to the precise arrangement shown in the drawings and that the drawings are provided merely as examples. The features, functions and advantages can be achieved independently in various embodiments of the claimed invention or may be combined in yet other embodiments.

FIG. 1 shows one embodiment of the core.

FIG. 2 shows one embodiment of a lamination of two core pieces.

FIG. 3 shows one method of sealing the inner core with an outer coating.

FIG. 4A shows one embodiment of the outer layer with a lap seam.

FIG. 4B shows one embodiment with a silicone gel layer.

FIG. 5 shows one method of sealing the outer layer with adhesive.

FIG. 6 shows one method of heat sealing the overlapping seam of the outer layer.

FIG. 7 shows a cross sectional view of one embodiment of the vibration reduction pad under a rubber mat.

FIG. 8 shows one embodiment of the vibration reduction pad between a rubber mat and a floor.

FIG. 9 shows an example embodiment of the vibration reduction system installed in a transport system.

FIG. 10A shows of one embodiment of the vibration reduction pad in sections.

FIG. 10B shows of one embodiment of the vibration reduction pad core with staggered laminations.

### DETAILED DESCRIPTION

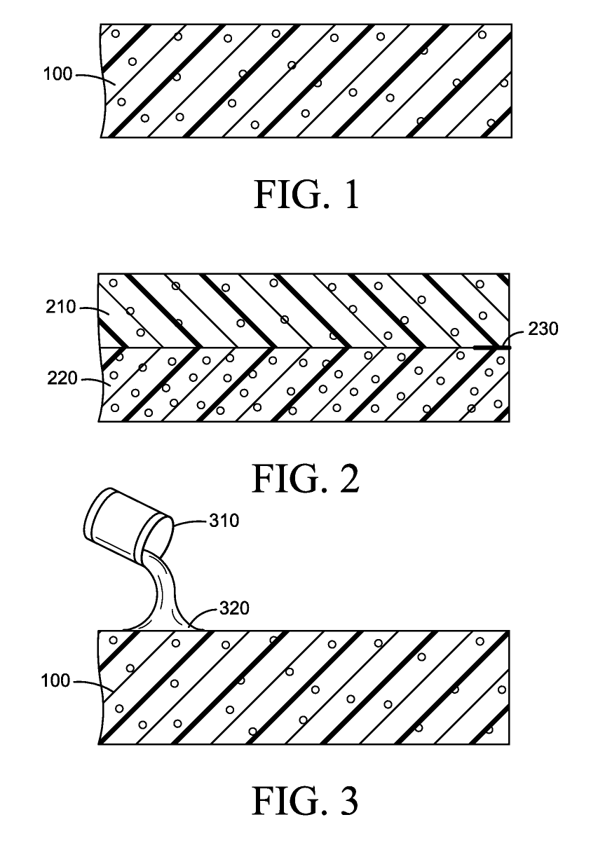

FIG. 1 shows one embodiment of the core 100 of the vibration reduction pad. The core 100 is typically a high-density foam of polyethylene, polyurethane, or polyolefin foam, pure or bonded or some combination. Most embodiments of the core employ a foam with a density between 5 and 10 pounds per cubic foot, hereafter abbreviated “pcf”. Note that the core may be a single layer of material as depicted in FIG. 1 or a lamination of two or more layers as shown in other figures.

FIG. 2 shows a core embodiment that is the lamination of two separate laminations of foam 210 and 220. The two laminations 210 and 220 can be simply held together by the outer layer discussed later. Other methods bond the two laminations with adhesive 230 placed between the two laminations 210 and 220. The adhesive 230 can be spread between the entire interface between the laminations 210 and 220, at selected spots, or along the outer edge of the two laminations 210 and 220. Still other bonding methods are possible including, but not limited, to ultrasonic or dielectric welding. The density of the laminations is typically between 5 pcf and 10 pcf. The densities of the two laminations can be the same or different. For example one embodiment may use an upper lamination 210 with a density of 10 pcf and a lower lamination 220 with a density of 5 pcf. The result gives a harder upper surface with a vibration reduction lower layer.

FIG. 3 shows one embodiment of adding a tough moisture barrier to the core 100. An outer coating 320 is added to one or more sides of the core 100. This coating process is depicted in FIG. 3 as the coating material 320 is poured out of a container 310 onto the core 100. In actual production, a coating material 320 can be applied by a number of automated methods known to those skilled in the art. Example methods of application include, but are not limited to, pouring, painting, spraying, wrapping and sealing and extruding.

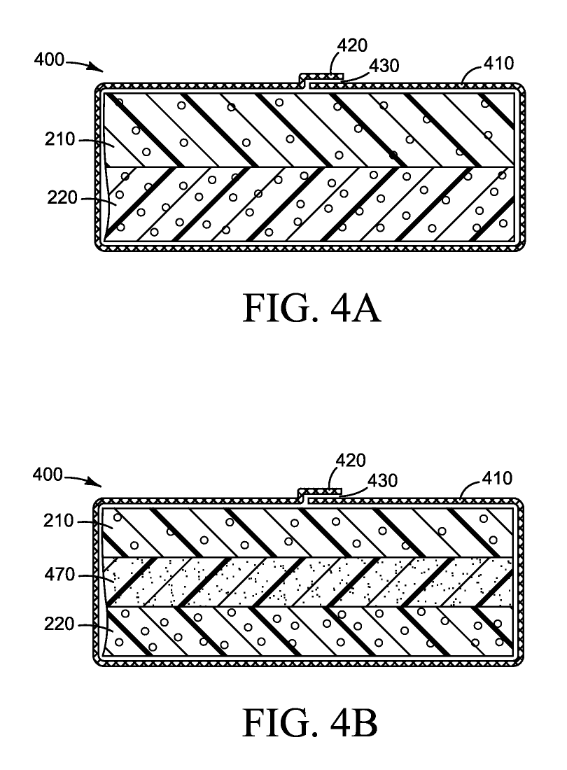

FIG. 4A shows another embodiment of an outer layer 410. In FIG. 4 the laminated core of FIG. 2 is again shown as two foam laminations 210 and 220. This core is wrapped with an outer layer 410 of a moisture proof fabric to form a vibration reduction pad 400. Example fabrics include but are not limited to woven fabrics consisting of an inner weave made of PVC; Nylon, Polyester, Nomex, or Fiberglass material and coated with Polyurethane, Urethane, Hypalon, Nitril, Neoprene, PVC, Elvaloy, or Silicone. The densities of 18-45 ounces per square yard work well although other densities of the outer layer 410 are also possible. By sealing the core with an outer layer, moisture and contamination are kept away from the core. The outer layer maintains the vibration reducing principles of the core, which can be diminished with the introduction of fluids. This prolongs the life of the core material and reduces bacterial growth caused by animal urine and feces. Cleaning of the vibration reduction pads is also made easier since only the outer layer is exposed. FIG. 4A shows the vibration reduction pad 400 in cross section for the sake of clarity. In practice, the core is wrapped or sealed on all faces and edges to protect the core from contamination.

Such fabrics also exhibit good puncture and abrasion resistance. The fabric 410 typically has an overlapped seam 420. The interface 430 between the two pieces of fabric is depicted as a simple overlap. In FIG. 4A and following figures, the outer layer 410 is shown as being slightly away from and not touching the core. This is only for the sake of clarity in the figures. It is usual that the fabric outer layer 410 contacts the core 100 or laminates 210 and 220. It is also possible that some embodiments attach the outer layer to the core 100 or laminates 210 and 220 with adhesive or other joining methods.

FIG. 4B shows an embodiment with three laminations. Similar to FIG. 4A the laminated core of FIG. 2 is wrapped with an outer layer 410 of a moisture proof fabric to form a vibration reduction pad 400. Additionally a silicone gel or silicone gel based padding 470 ranging between 0.25 and 0.5 inches thick is interposed between laminations 210 and 220. The thickness of laminations 210 and 220 are sized to produce an overall vibration reduction pad 400 thickness of about 2.0 inches or less. The typical vibration reduction pad 400 thickness ranges between 1.0 and 1.5 inches. Similar to FIG. 4A the core is sealed with an outer layer 410 so moisture and contamination are kept away from the core.

While a number of silicone gel products are suitable, one version is offered by
Impact Gel Corporation
15833 W. Judd St.
Ettrick, Wis. 54627
1-608-525-3630
www.impactgel.com

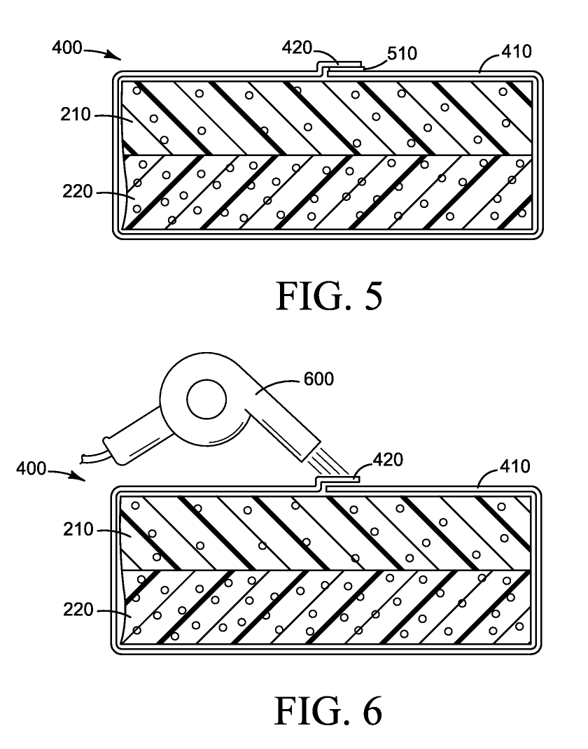

FIG. 5 shows another embodiment the pad 400. In this embodiment the overlapped seam 420 of is sealed with an adhesive 510. The type of adhesive is chosen based on the type of fabric and coating and is well known to those skilled in the art. While some figures show a single core 100 and other figures show a laminate core of two laminations 210 and 220, while still other figures show three laminations, it is to be understood that the vibration reduction pad can use either type of construction.

FIG. 6 shows another embodiment of the pad 400. In this embodiment the overlapped seam 420 of is heat sealed with a heat gun 600. Many types of outer layer 410 can be sealed with heat. The exact method of heat sealing depends upon the type of material chosen for the outer layer 410. Note that the depiction of a heat gun 600 does not preclude the use of more sophisticated means such as heated rollers, ultrasonics, dielectric welding or seaming methods adapted to automated production. The exact heat sealing method is chosen based on production volumes, capital budgets and other considerations. Automated heat sealing of materials is well known to those skilled in the art.

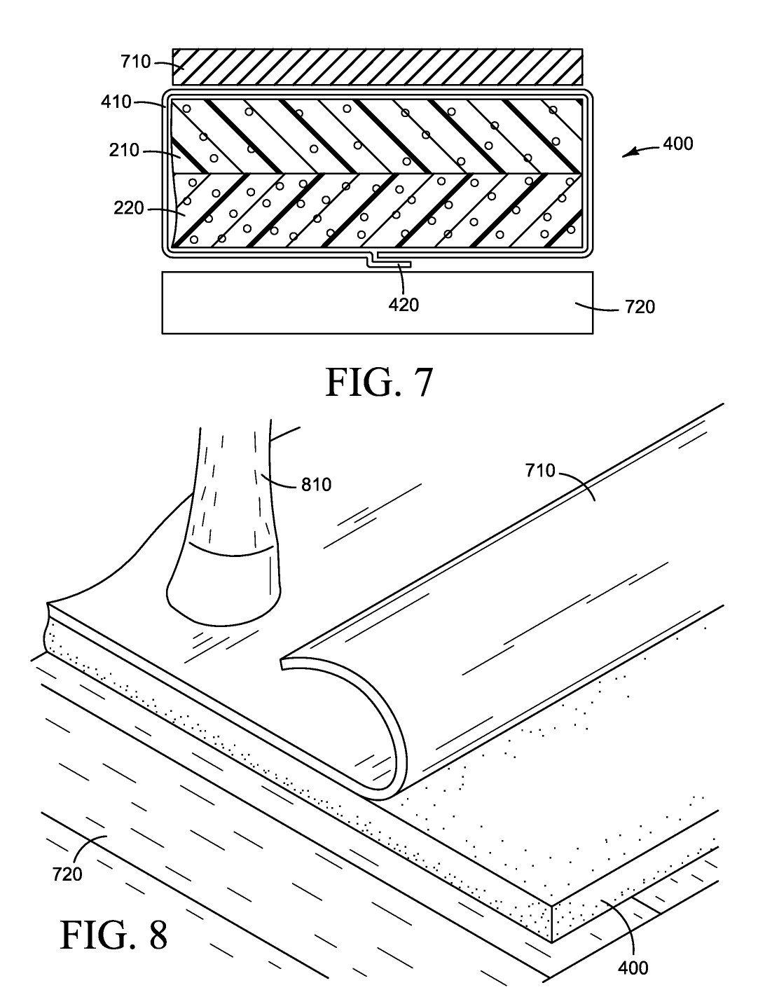

FIG. 7 shows a cross section of the vibration reduction pad 400 in use. The pad 400 rests on the floor of a stall, pen, trailer, rail car or other containment/transport system. The seam 420 is against the floor 720. A rubber mat 710 is on top of the pad 400. The upper surface of the rubber mat 710 opposite the pad 400 is the surface facing the hooves of the animals (not shown). The method of use can use a thin rubber mat 710 to protect and prolong the life of the vibration reduction pad 400. Note in FIG. 7 that the seam 420 is shown facing the floor 720. In actual use, the seam 420 can be against the floor 720 or against the rubber mat 710. Other uses can employ the vibration reduction pad 400 alone without the use of the rubber mat 710. Note that in this disclosure, the term “rubber mat” is used in a general sense and is not limited to natural rubber. A number of materials are currently in use as flooring for animals including but not limited to rubber, plastics, composites and organic materials.

FIG. 8 shows pictorial example of the vibration reduction pad 400 in use. The pad 400 rests on a floor 720. A rubber mat 710 lays on top of the pad 400. The animals represented by a hoof 810 stand on the mat 710. Despite the hardness of the mat 710, underlying pad 400 reduces the vibration transmitted up from the floor 720. The use of a hoof 810 in FIG. 8 is used to represent any type of animal in general that can benefit from the vibration reduction pad. Non-hoofed animals can also benefit. Animals accustomed to laying down can also benefit by the reduction of vibrations transmitted to their bodies.

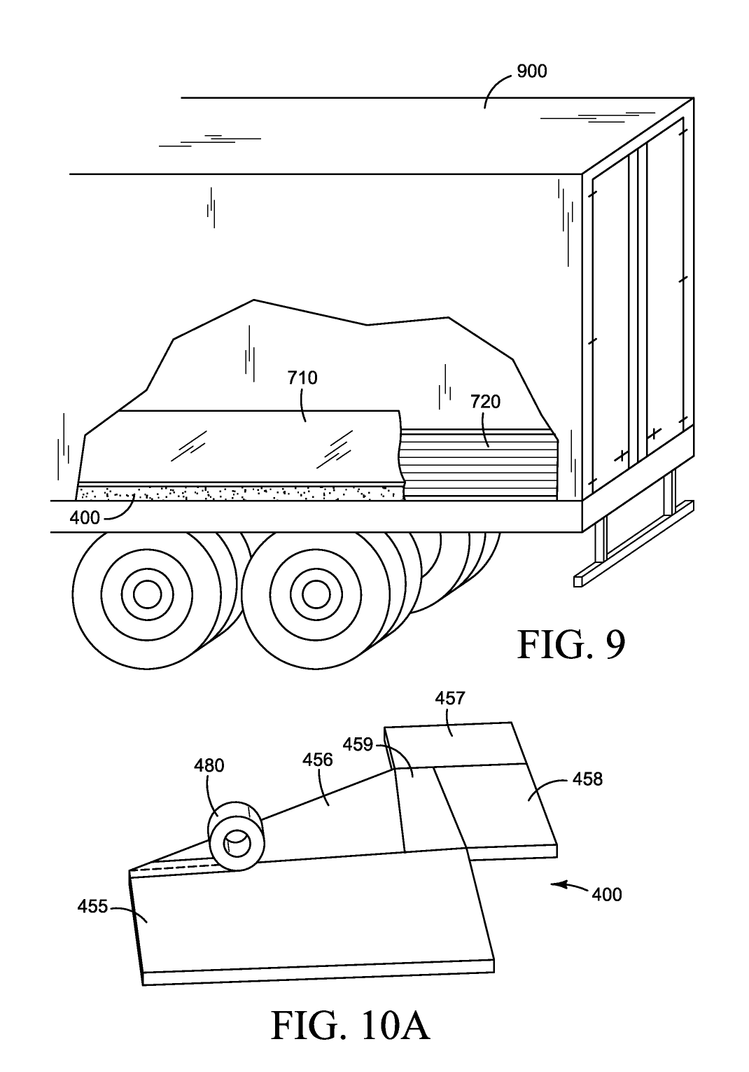

FIG. 9 shows one embodiment of the vibration reduction pad 400 in a trailer 900. The vibration reduction pad 400 rests on the floor 720 of the trailer 900. An optional rubber mat 710 rests on the pad 400 While FIG. 9 shows the trailer of a semi-truck trailer, the pad 400 is applicable to horse trailers, stock trailers, rail cars and even stationary enclosures such as stalls, pens and barns.

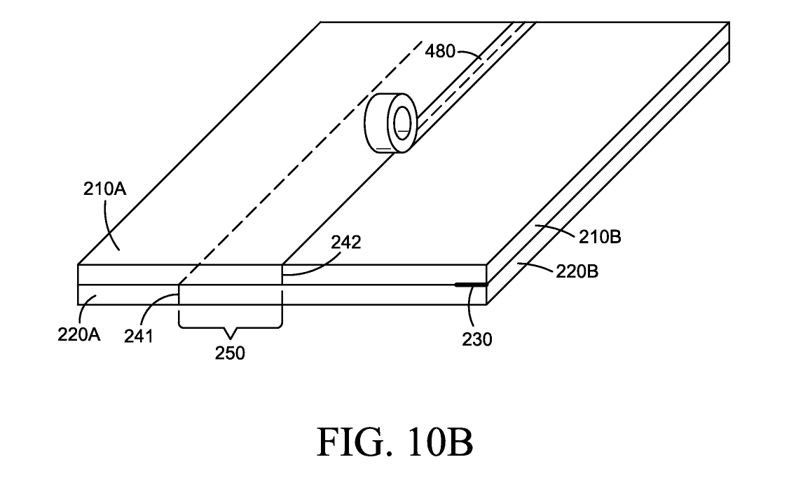

FIG. 10A shows another embodiment of the vibration reduction pad 400 custom fit to a trailer (not shown). FIG. 10A emphasizes and demonstrates that the vibration reduction pad is versatile and can be made in any shape. FIG. 10A depicts the division of the pad 400 into five segments 455, 456, 457, 458 and 459. The whole pad 400 can be built from a number of segments 455-459. This segmentation allows easy handling of large pads so that they can be moved by one person if necessary. Other segmentation advantages include easier shipping and storage. Sealing tape 480, sometimes called “gorilla tape” can be used to seal the interfaces between the segments 455-459. In FIG. 10A only a small section of sealing tape 480 is shown for the sake of clarity. In practice all the interfaces, indicated by lines, between the segments 455-459, are sealed and/or bonded with tape 480 or adhesive. In other embodiments, the vibration reduction pad 400 can be made of a number of standardized shapes. These standardized shapes can then be arranged to match a given floor layout. Such a system reduces the amount of custom sizes needed.

In other embodiments, core segments can be pieced together to fit an enclosure. Following the fitting of multiple core pieces such as those of FIG. 1 or 2, a continuous piece of outer layer 410 can cover and seal all the core segments together. Another advantage of piecing together core segments is that the laminations can be staggered. This staggering of laminations in the core adds to the strength and structural integrity of the overall core and reduces the chance of a gap or shifting of the laminations within the core. This technique is analogous to the staggering of bricks in a masonry wall.

FIG. 10B shows an embodiment using two laminations with staggered joints. The upper laminations 210A and 210B meet at joint 242, while the lower laminations 220A and 220B meet at joint 241. The two joints 241 and 242 are staggered or offset as indicated by reference 250. The laminations 210A and 201B as well as 220A and 220B can be adhesively glued to each other as indicted by 230. The reference 230 shows only one area of adhesive for clarity. Various embodiments can have a continuous line of adhesive or spot applications of adhesive either between laminations as indicated by reference 230 or at joints 241 and 242.

Both of the two methods described above, sealing adjoining edges of vibration reduction pads with a sealing tape or covering and sealing multiple core pieces with a continuous outer layer, have advantages. Both allow custom fits to the floors of transport systems or enclosures. Both seal the inner core from contamination. Both reduce or eliminate the shifting of multiple pads or cores. Both provide a continuous floor surface. Trailers have a multitude of the geometries due to customization and options such as feeders, tack rooms and even production variations. The various embodiments disclosed above can provide a customizable, smooth, wall to wall fit without creating dangerous uneven surfaces.

### ADVANTAGES

Overall this system with the vibration reduction pad 400 reduces the stress, fatigue, and possible injury to animals during transportation. Given the many equestrian shows and competitions around the country, prized animals spend considerable time in transit. Equestrian competitors and their riders travel from competition to competition. It is not unusual for top competitors to travel thousands of miles a year and spend hundreds of hours in transit. Examples of the many equestrian competitions include rodeos, cutting horse competitions, horse shows and horse races. All these competitions involve the trailering and transport of valuable animals, some even worth millions of dollars.

Further advantages are found outside animal transportation applications. Work environments where human workers are required to stand are also useful. The vibration reduction pad also eases the joint stress and fatigue on people. Additionally, the pads can be easily removed and cleaned in sterile or low particle environments such as operating or clean rooms. The foam material is sealed from either contaminating or being contaminated by the environment. In other applications, the outer covering layer can include antistatic materials in environments susceptible to static accumulations or discharge.

Although this invention has been described in terms of certain embodiments, other embodiments that are apparent to those of ordinary skill in the art, including embodiments that do not provide all of the features and advantages set forth herein, are also within the scope of this invention. Rather, the scope of the present invention is defined only by reference to the appended claims and equivalents thereof.

I claim

1. A vibration reduction pad adapted to the floors of animal transport and containment systems, the vibration pad comprising:
a core comprising one or more foam laminations, the foam laminations having a density ranging from 5 to 10 pounds per cubic foot, the core further having a thickness ranging from 0.5 to 1.0 inches;
an outer layer of moisture-proof, puncture and abrasion resistant woven fabric, the fabric having a weight between 18 and 45 ounces per square yard;
the outer layer further surrounding all sides and faces of the core, the outer layer sealing the core layer against outside contaminates.

2. The vibration reduction pad according to claim 1, wherein the core laminations are chosen from the group consisting of polyethylene, polyolefin, polyurethane and combinations thereof.

3. The vibration reduction pad according to claim 1, wherein the core laminations are laminated together with adhesive.

4. The vibration reduction pad according to claim 1, further comprising adhesives for the sealing of the outer layer against outside contaminates.

5. The vibration reduction pad according to claim 1, further comprising heat sealing techniques for the sealing of the outer layer against outside contaminates.

6. The vibration reduction pad according to claim 1, further comprising a plurality of vibration reduction pads sealed at adjoining edges.

7. A vibration reduction pad adapted to the floors of animal transport and containment systems, the vibration pad comprising:
a core comprising a plurality of foam laminations, the foam laminations having a density ranging from 5 to 10 pounds per cubic foot, the core further having a thickness ranging from 0.25 to 0.5 inches;
a silicone gel layer interposed between two of the plurality of foam laminations, the silicone gel layer having a thickness ranging from 0.25 to 0.5 inches;
an outer layer of moisture-proof, puncture and abrasion resistant woven fabric, the fabric having a weight between 18 and 45 ounces per square yard;
the outer layer further surrounding all sides and faces of the core, the outer layer sealing the core layer against outside contaminates.

8. The vibration reduction pad according to claim 7, wherein the core laminations are chosen from the group consisting of polyethylene, polyolefin, polyurethane and combinations thereof.

9. The vibration reduction pad according to claim 7, further comprising adhesives for the sealing of the outer layer against outside contaminates.

10. vibration reduction pad according to claim 7, further comprising heat sealing techniques for the sealing of the outer layer against outside contaminates.

11. vibration reduction pad according to claim 7, further comprising a plurality of vibration reduction pads sealed at adjoining edges.

12. An animal containment unit comprising:
a floor;
a rubber mat;
a vibration reduction pad interposed between the floor and the mat, the pad comprising
a core, the core comprising a plurality of foam laminations, the foam laminations having a density ranging from 5 to 10 pounds per cubic foot, the core further having a thickness ranging from 0.5 to 2.0 inches;
an outer layer of moisture-proof, puncture and abrasion resistant woven fabric, the fabric having a weight between 18 and 45 ounces per square yard;
the outer layer further surrounding all sides and faces of the core, the outer layer sealing the core layer against outside contaminates.

13. The animal containment unit according to claim 12, wherein the foam laminations are chosen from the group consisting of polyethylene, polyolefin, polyurethane and combinations thereof.

14. The animal containment unit according to claim 12 further comprising a silicone gel layer interposed between two of the plurality of foam laminations, the silicone gel layer having a thickness ranging from 0.25 to 0.5 inches;

15. An animal containment unit of claim 12 wherein the vibration reduction pad further comprises a plurality of vibration reduction pads sealed at adjoining edges.

16. An animal containment unit of claim 15 wherein the sealing at adjoining edges of the vibration reduction pads is accomplished with sealing tape.

17. The vibration reduction pad according to claim 12, further comprising adhesives for the sealing of the outer layer against outside contaminates.

18. The vibration reduction pad according to claim 12, further comprising heat sealing techniques for the sealing of the outer layer against outside contaminates.

19. The vibration reduction pad according to claim 12, wherein one of more of the plurality of foam laminations comprises a plurality of foam pieces meeting at a joint, the joints of different laminations being staggered.

20. The vibration reduction pad according to claim 1, wherein one of more of the foam laminations comprises a plurality of foam pieces meeting at a joint, the joints of different laminations being staggered.
